(19) United States
(12) Patent Application Publication
(10) Pub. No.: US 2018/0252876 A1
(43) Pub. Date: Sep. 6, 2018

(54) OPTICAL APPARATUS, STUB DEVICE

(71) Applicant: Sumitomo Electric Industries, Ltd., Osaka (JP)

(72) Inventors: Mitsuharu Hirano, Yokohama-shi (JP); Akira Furuya, Yokohama-shi (JP)

(73) Assignee: SUMITOMO ELECTRIC INDUSTRIES, LTD., Osaka (JP)

(21) Appl. No.: 15/903,986

(22) Filed: Feb. 23, 2018

(30) Foreign Application Priority Data
Mar. 2, 2017 (JP) 2017-039616

(51) Int. Cl. G02B 6/42

(52) U.S. Cl. CPC G02B 6/421; G02B 6/4298; G02B 6/4239

(57) ABSTRACT

A stub device includes: a holder having a first portion and a second portion, the first portion and the second portion being arranged in a direction of a first axis, the first portion having a first end face and a second end face, and the second portion having an installation face; and optical fibers held by the holder to extend in the direction of the first axis. Core ends of the optical fibers and the first end face are arranged along a first reference plane. The second end face and the installation face extend along second and third reference planes, respectively, which are inclined with the first reference plane at acute angles. The second end face is apart from cores of the optical fibers in the first portion, and the installation face having a surface roughness larger than that of the second end face.

### BACKGROUND OF THE INVENTION

### Field of the Invention

The present invention relates to an optical apparatus, and a stub device. This application claims the benefit of priority from Japanese Patent Application No. 2017-039616 filed on Mar. 2, 2017, which is herein incorporated by reference in its entirety.

### Related Background Art

U.S. Pat. No. 7,162,124 (referred to as “Patent Document 1”) discloses an apparatus having an optical fiber and a semiconductor chip.

### SUMMARY OF THE INVENTION

A stub device according to one aspect of the present invention includes: a holder having a first portion and a second portion, the first portion and the second portion being arranged in a direction of a first axis, the first portion having a first end face and a second end face, and the second portion having an installation face; and optical fibers held by the holder so as to extend in the direction of the first axis, the optical fibers having core ends, and the core ends and the first end face of the holder being arranged along a first reference plane, the second end face of the holder extending along a second reference plane, the second reference plane being inclined with the first reference plane at an acute angle, and the second end face of the holder being apart from cores of the optical fibers in the first portion, the installation face being apart from cores of the optical fibers in the second portion and extending along a third reference plane, and the third reference plane being inclined with the first reference plane at an acute angle, the optical fibers being arranged along a fourth reference plane, the fourth reference plane being inclined with the first reference plane at an acute angle, and the installation face having a surface roughness larger than that of the second end face.

An optical apparatus according to another aspect of the present invention includes: a stub device; a semiconductor device having a first region and a second region, the second region including an optical coupling element optically coupled to the stub device; and a resin body disposed between the semiconductor device and the stub device. The stub device includes: a holder having a first portion and a second portion, the first portion and the second portion being arranged in a direction of a first axis, the first portion having a first end face and a second end face, and the second portion having an installation face; and optical fibers held by the holder so as to extend in the direction of the first axis, the optical fibers having core ends, and the core ends and the first end face of the holder being arranged along a first reference plane, the second end face of the holder extending along a second reference plane, the second reference plane being inclined with the first reference plane at an acute angle, and the second end face of the holder being apart from cores of the optical fibers in the first portion, the installation face being apart from cores of the optical fibers in the second portion and extending along a third reference plane, the third reference plane being inclined with the first reference plane at an acute angle, and the installation face being supported by the first region, the optical fibers being arranged along a fourth reference plane, the fourth reference plane being inclined with the first reference plane at an acute angle, and the installation face having a surface roughness larger than that of the second end face.

### BRIEF DESCRIPTION OF THE DRAWINGS

The above-described objects and the other objects, features, and advantages of the present invention become more apparent from the following detailed description of the preferred embodiments of the present invention proceeding with reference to the attached drawings.

FIG. 1A is a perspective view showing a stub device and a semiconductor device according to the present embodiment.

FIG. 1B is a vertical cross-sectional view showing the optical apparatus including the stub device and the semiconductor device according to the present embodiment.

FIG. 2A is a perspective view showing a stub device and the semiconductor device according to the present embodiment.

FIG. 2B is a vertical cross-sectional view showing the optical apparatus including the stub device and the semiconductor device according to the present embodiment.

FIG. 3A is a perspective view showing a stub device and the semiconductor device according to the present embodiment.

FIG. 3B is a vertical cross-sectional view showing the optical apparatus including the stub device and the semiconductor device according to the present embodiment.

FIG. 4A is a plan view showing a silicon photonics semiconductor device according to the present embodiment.

FIG. 4B is a cross-sectional view, taken along line IVb-IVb shown in FIG. 4A, showing the silicon photonics semiconductor device according to the present embodiment.

FIGS. 5A and 5B are schematic views each showing a major step in the method for fabricating the stub device according to the present embodiment.

FIGS. 6A, 6B, and 6C are schematic views each showing a major step in the method according to the present embodiment.

FIGS. 7A, 7B, 7C, 7D, 7E, and 7F are schematic views each showing a major step in the method according to the present embodiment.

### DESCRIPTION OF THE EMBODIMENTS

Patent Document 1 discloses as follows. The chip supports the side face of the optical fiber to keep it in place. The optical fiber includes an end having a single oblique face, and an interface extending from the end. An optical alignment of the optical fiber with the chip needs angular adjustments in both an axial direction of the optical fiber on the chip and an angle about the axial direction. Handling the optical fiber makes it complicated to develop these alignments.

Patent Document 1 also discloses as follows. The optical fiber is fixed to the top face of the semiconductor chip at the flat interface thereof to be optically coupled to the semiconductor chip. Such an interface can be fabricated by polishing or highly precise grinding to enable a low irregular reflection. The interface thus fabricated is flat and narrow in width. The flat interface is needed by reduction in optical scattering, and the width of the interface is determined by the size of the optical fiber.

It is an object of one aspect of the present invention to provide a stub device which can reduce optical scattering in optical input and output of light propagating in an optical fiber having an oblique face and provide fixation of the optical fiber with a satisfactory adhesive strength. It is another object of the present invention to provide an optical apparatus including the stub device.

Embodiments according to the above aspects are described below.

A stub device according to an embodiment includes: (a) a holder having a first portion and a second portion, the first portion and the second portion being arranged in a direction of a first axis, the first portion having a first end face and a second end face, and the second portion having an installation face; and (b) optical fibers held by the holder so as to extend in the direction of the first axis, the optical fibers having core ends, and the core ends and the first end face of the holder being arranged along a first reference plane, the second end face of the holder extending along a second reference plane, the second reference plane being inclined with the first reference plane at an acute angle, and the second end face of the holder being apart from cores of the optical fibers in the first portion, the installation face being apart from cores of the optical fibers in the second portion and extending along a third reference plane, and the third reference plane being inclined with the first reference plane at an acute angle, the optical fibers being arranged along a fourth reference plane, the fourth reference plane being inclined with the first reference plane at an acute angle, and the installation face having a surface roughness larger than that of the second end face.

The stub device provides the installation face, which can be fixed to a supporting base by use of an adhesive, with a surface roughness larger than that of the second end face. The stub device has a first face and a second face. The first face of the stub device includes the first end face of the holder and the core ends of the optical fibers, and extends along the first reference plane. The second face of the stub device also includes the second end face of the holder, and extends along the second reference plane. The first face of the stub device (extending along the first reference plane), which is inclined with the fourth reference plane at an acute angle, has an inclination associated with the installation face (extending along the third reference plane). The first face of the stub device enables reflection of light which allows the direction of light to change from that of incoming light, which propagates in the optical fibers extending in the direction of the first axis, to that of outgoing light propagating to pass through the second face in a direction different from that of the first axis. Alternatively, the first face enables reflection of light which allows the direction of light to change from that of incoming light, which is incident on the second face at a desired angle in a direction different from that of the first axis, to that of outgoing light propagating in the optical fiber in the direction of the first axis. These reflections at the first face can change the propagation of light from one of the direction of the first axis and the different direction to the other. The direction of the first axis in the holder (the axial direction of the optical fibers) is associated with that of the installation face (extending along the third reference plane) on the supporting base supporting the stub device at the installation face, which extends along the third reference plane. The stub device does not include any part extending beyond the third reference plane (a level of the installation face).

In the stub device according to an embodiment, the installation face has a surface roughness Ra of larger than 0.05 micrometers.

The stub device may provide the installation face, which extends along the third reference plane in the stub device, with a surface roughness of larger than 0.05 micrometers.

The stub device according to an embodiment further includes a protecting member, the protecting member being disposed on the first end face and reaching an edge at which the first end face and the second end face meet.

The stub device is provided with the protecting member extending on the first end face to an edge shared by the first and second end faces. This protecting member on the first end face can prevent an adhesive from spreading to cover the first end face.

In the stub device according to an embodiment, the second end face extends to connect the installation face with the first end face.

The stub device is provided with the second end face extending along the second reference plane, which is inclined with the fourth reference plane at an angle of larger than zero degrees, allowing the connection of the installation face to the first end face.

In the stub device according to an embodiment, the holder includes a connection face extending along a fifth reference plane to connect the second end face with the installation face, and the fifth reference plane intersects the first axis, and the first end face and the installation face extend in the direction of the first axis.

The stub device is provided with the connection face that extends from the second end face to the installation face, which is provided on the second reference plane inclined with the fourth reference plane at an angle of larger than zero degrees.

In the stub device according to an embodiment, the optical fibers each include a cladding face extending along the second reference plane in the direction of the first axis to the connection face.

The stub device allows light reflected at the first end face to propagate in the cladding of each of the optical fibers from one of the first and second end faces of the stub device to the other in the direction of a second axis intersecting that of the first axis.

In the stub device according to an embodiment, the second end face is apart from side faces of the optical fibers.

The stub device allows light reflected at the first end face to propagate in the holder and the cladding of each of the optical fibers from one of the first and second end faces of the stub device to the other in the direction of a second axis intersecting that of the first axis.

An optical apparatus according to an embodiment includes: (a) a stub device; (b) a semiconductor device having a first region and a second region, the second region including an optical coupling element optically coupled to the stub device; and (c) a resin body disposed between the semiconductor device and the stub device. The stub device includes: a holder having a first portion and a second portion, the first portion and the second portion being arranged in a direction of a first axis, the first portion having a first end face and a second end face, and the second portion having an installation face; and optical fibers held by the holder so as to extend in the direction of the first axis, the optical fibers having core ends, and the core ends and the first end face of the holder being arranged along a first reference plane, the second end face of the holder extending along a second reference plane, the second reference plane being inclined with the first reference plane at an acute angle, and the second end face of the holder being apart from cores of the optical fibers in the first portion, the installation face being apart from cores of the optical fibers in the second portion and extending along a third reference plane, the third reference plane being inclined with the first reference plane at an acute angle, and the installation face being supported by the first region, the optical fibers being arranged along a fourth reference plane, the fourth reference plane being inclined with the first reference plane at an acute angle, and the installation face having a surface roughness larger than that of the second end face.

The stub device provides the installation face with a surface roughness larger than that of the second end face, and the stub device is fixed to the semiconductor device at the installation face by use of an adhesive. The first face of the stub device (extending along the first reference plane) has an inclination associated with the installation face (extending along the third reference plane). Optical reflection at the first face allows the propagating direction of light to change from the direction of the first axis to a direction different from that of the first axis, so that this reflection can produce outward light from the light propagating in the optical fiber, and also allows the propagating direction of light to change from a direction of incoming light different from that of the first axis at a desired angle to that of the first axis, so that this reflection can produce light propagating in each of the optical fibers in the direction of the first axis from the incoming light. These reflections at the first face allow the propagating direction of light to change from one of the different direction and the direction of the first axis of the optical fibers to the other. The stub device, which is supported at the installation face (extending along the third reference plane) by a supporting base, allows the optical fibers in the holder to extend in the direction associated with the orientation of the installation face (extending along the third reference plane). The stub device has no part extending beyond the third reference plane (the level of the installation face).

The teachings of the present invention can be readily understood by considering the following detailed description with reference to the accompanying drawings shown as examples. Referring to the accompanying drawings, embodiments according to the optical apparatus and the stub device will be illustrated below. When possible, the same portions will be denoted by the same reference numerals.

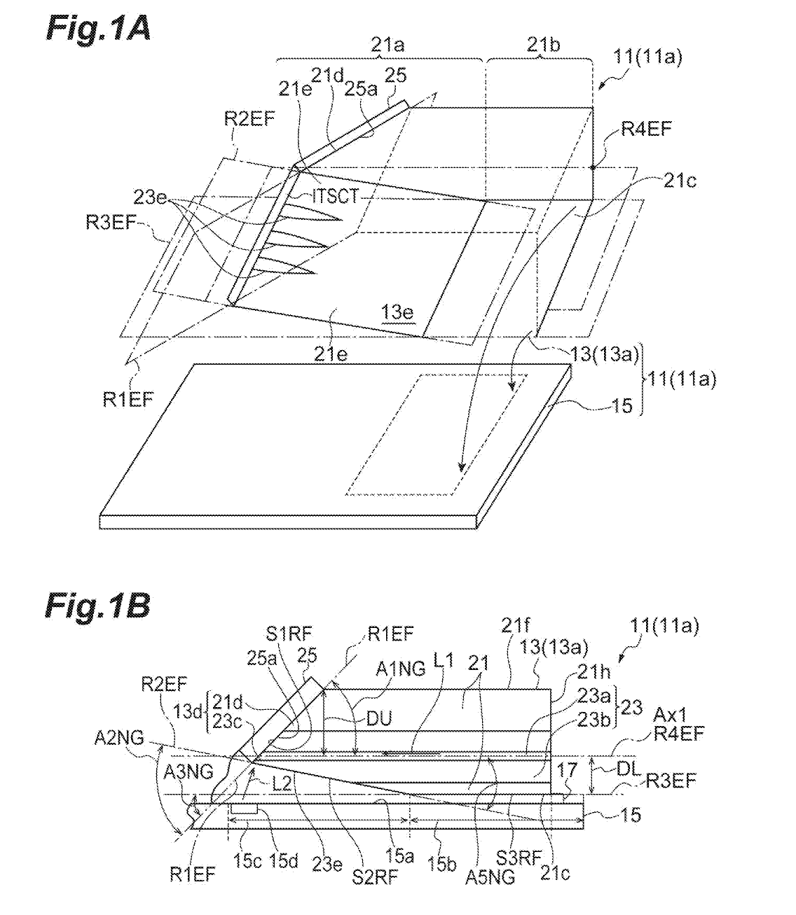

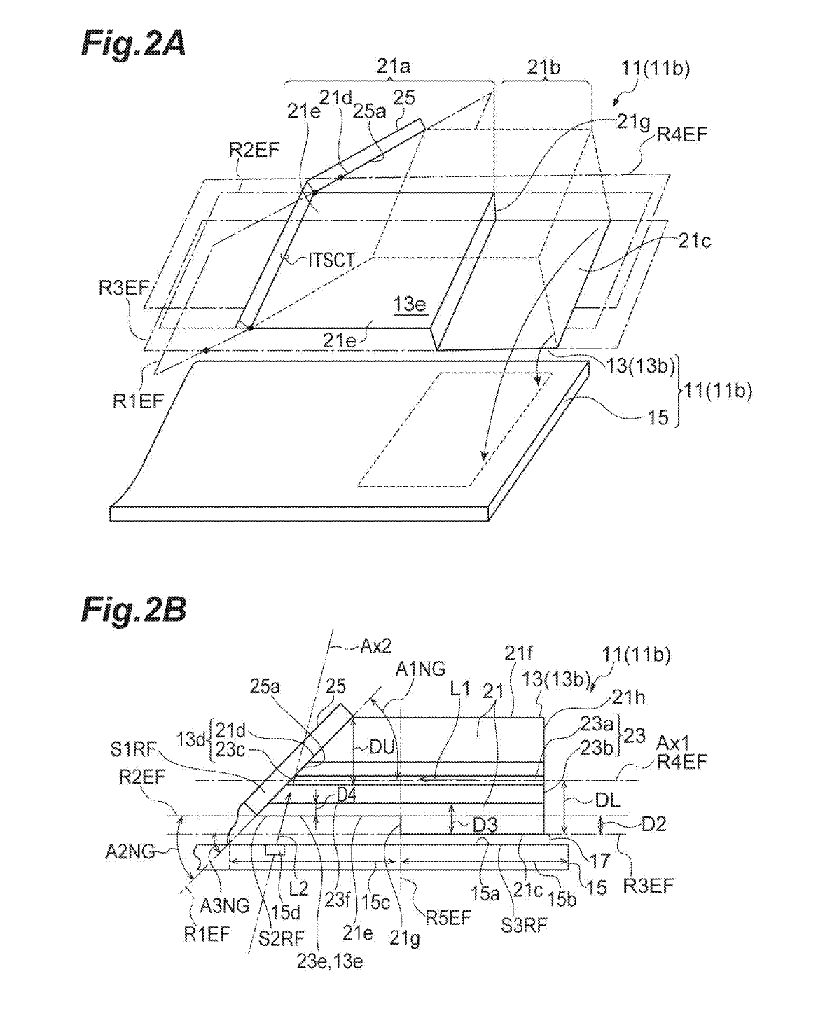

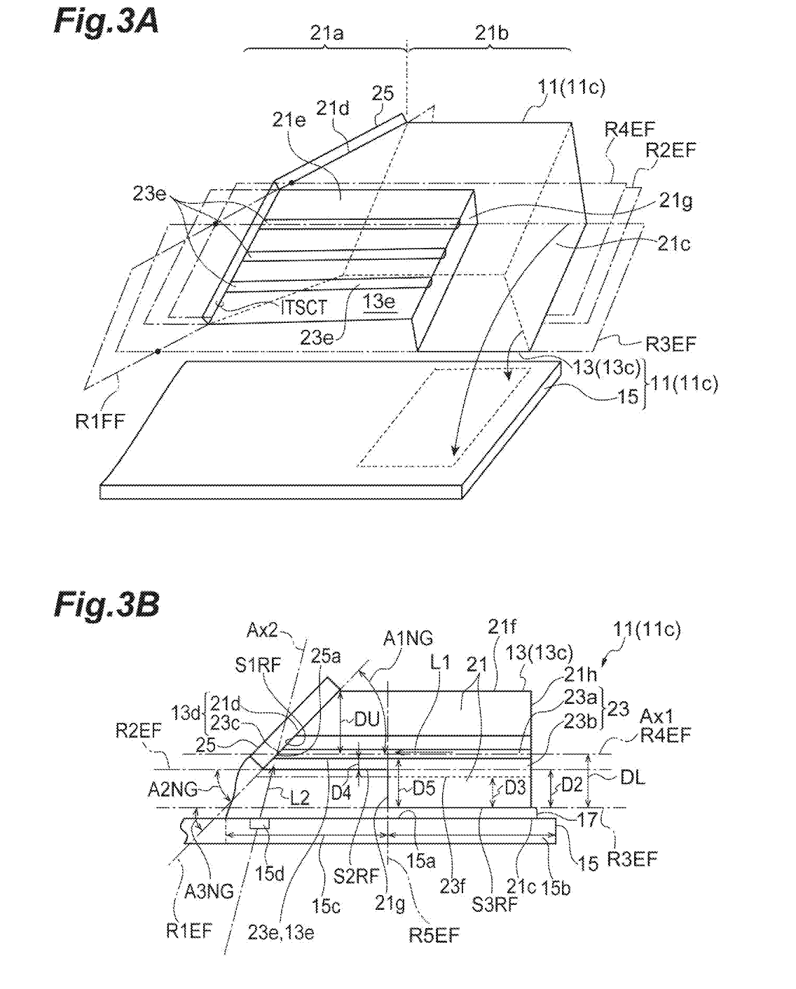

Referring to FIGS. 1A, 1B, 2A, 2B, 3A and 3B, a description will be given of an optical apparatus and a stub device according to embodiments. FIG. 1A is a perspective view showing a stub device 13 (13a) and a semiconductor device 15 according to the present embodiment. In FIG. 1A, the stub device 13 (13a) and the semiconductor device 15 are depicted apart from each other to show an installation face and an optical connection face of the stub device 13 (13a). FIG. 1B is a vertical cross-sectional view showing an optical apparatus 11a (11) including the stub device 13 (13a) and the semiconductor device 15 according to the present embodiment. FIG. 2A is a perspective view showing a stub device 13 (13b) and the semiconductor device 15 according to the present embodiment. In FIG. 2A, the stub device 13 (13b) and the semiconductor device 15 are depicted apart from each other to show an installation face and an optical connection face of the stub device 13 (13b). FIG. 2B is a vertical cross-sectional view showing an optical apparatus 11b (11) including the stub device 13 (13b) and the semiconductor device 15 according to the present embodiment. FIG. 3A is a perspective view showing a stub device 13 (13c) and the semiconductor device 15 according to the present embodiment. In FIG. 3A, the stub device 13 (13c) and the semiconductor device 15 are depicted apart from each other to show an installation face and an optical connection face of the stub device 13 (13c). FIG. 3B is a vertical cross-sectional view showing an optical apparatus 11c (11) including a stub device 13 (13c) and the semiconductor device 15 according to the present embodiment.

The optical apparatus 11 (11a, 11b, and 11c) includes the stub device 13 (13a, 13b, and 13c), the semiconductor device 15 on which the stub device 13 (13a, 13b, and 13c) is to be disposed, and a resin body 17 disposed between the semiconductor device 15 and the stub device 13 (13a, 13b, and 13c). The semiconductor device 15 includes, for instance, a silicon photonics device.

The stub device 13 (13a, 13b, and 13c) includes a holder 21 and one or more optical fibers 23. Each of the optical fibers 23 has a core 23a and a cladding 23b. The optical fibers 23 have core ends. In the holder 21, the optical fibers 23 each extend in a direction of a first axis Ax1. The holder 21 has a first portion 21a and a second portion 21b. The first and second portions 21a and 21b are arranged in the direction of the first axis Ax1. The first portion 21a includes a first end face 21d associated with optical reflection, and a second end face 21e associated with optical coupling. The second portion 21b has an installation face 21c associated with installation on the supporting base. The optical fibers 23 are held by the holder 21 so as to extend in the direction of the first axis Ax1.

The core ends of the optical fibers 23 and the first end face 21d of the holder 21 are arranged along a first reference plane. The second end face 21e of the holder 21 extends along a second reference plane R2EF. The installation face 21c of the holder 21 extends along a third reference plane R3EF. The installation face 21c of the holder 21 is apart form the core 23a of each of the optical fibers 23. The cores 23a of the optical fibers 23 are apart from the second end face 21e of the holder 21. The optical fibers 23 extend along a fourth reference plane R4EF. The fourth reference plane R4EF is inclined with the first reference plane R1EF at a first acute angle A1NG. The second reference plane R2EF is inclined with the first reference plane R1EF at a second acute angle A2NG. The third reference plane R2EF is inclined with the first reference plane R1EF at a third acute angle A3NG. The first end face 21d has a first surface roughness (S1RF). The second end face 21e has a second surface roughness (S2RF). The installation face 21c has a third surface roughness (S3RF). The surface roughness (S3RF) of the installation face 21c is larger than the surface roughness (S2RF) of the second end face 21e. The vertical sections in FIGS. 1B, 2B and 3B each are taken along a reference plane perpendicular to the fourth reference plane R4EF.

The stub device 13 (13a, 13b, and 13c) is mounted on a supporting base, such as the semiconductor device 15, and fixed to the supporting base with an adhesive resin body 17 at the installation face 21c, which is provided with a surface roughness (S2RF) larger than that of the second end face 21e. Mounting the stub device 13 (13a, 13b, and 13c) on the semiconductor device 15 can make the height of the optical apparatus 11 (11a, 11b, and 11c) reduced. The stub device 13 (13a, 13b, and 13c) is connected to an external optical connecter with a guide member, such as a guide pin. This optical connecter to be coupled to the stub device 13 (13a, 13b, and 13c) is connected to the rear end face 21h of the second portion 21b of the stub device 13 (13a, 13b, and 13c). This connection allows the optical connecter to have a fiber ribbon oriented to a direction along which the principal face of the semiconductor device 15 extends, not in a direction normal to the principal face of the semiconductor device 15. This orientation of the axial direction of the optical fibers in the holder is also effective in making the height of the optical apparatus 11 (11a, 11b, and 11c) reduced. Aligning the installation face 21c with the principal face of the semiconductor device 15 allows the positioning of the ends of the optical fibers 23 in the holder 21 with respect to the installation face 21c in the normal direction. Inventors' teachings reveal that the stub device 13 (13a, 13b, and 13c) disposed on the principal face of the semiconductor device 15 receives an external force through the optical connecter in connecting it to the stub device 13 (13a, 13b, and 13c). This external force is applied to the stub device 13 (13a, 13b, and 13c) fixed to the principal face so as to separate the stub device 13 (13a, 13b, and 13c) from the semiconductor device 15, so that the installation face 21c should enable an adhesive strength that can overcome the external force.

The top surface of the semiconductor device 15 includes, for instance, an oxide film, nitride film, or polyimide film. These films are used in terms of the fabricating process of the semiconductor device 15 and the performance of the semiconductor device 15, such as moisture resistance. The semiconductor device 15 is not likely to have all of surface properties demanded from the attaching of the stub device 13 (13a, 13b, and 13c) to the semiconductor device 15. What is needed is to make the fixation between the stub device 13 (13a, 13b, and 13c) and the semiconductor device 15 less dependent on material of the top surface of the semiconductor device 15.

The stub device 13 (13a, 13b, and 13c) has a first face 13d and a second face 13e. The first face 13d of the stub device 13 (13a, 13b, and 13c) includes the first end face 21d of the holder 21 and the core ends 23c of the optical fibers 23, and extends along the first reference plane R1EF. The second face 13e of the stub device 13 (13a, 13b, and 13c) includes the second end face 21e of the holder 21, and extends along the second reference plane R2EF. The structure of the stub device 13 (13a, 13b, and 13c) associates the inclination of the first face 13d (extending along the first reference plane), which is inclined with the fourth reference plane R4EF at an acute angle, with the installation face 21c (extending along the third reference plane R3EF). The first face 13d enables optical reflection that can change incoming light propagating in each of the optical fibers in the direction of the first axis Ax1 into outgoing light propagating in a direction different from the first axis Ax1 to pass through the second face 13e. Further, the first face 13d also enables optical reflection that can change light coining through the second face 13e at a desired angle in a direction different from the first axis Ax1 into light propagating in the optical fiber in the direction of the first axis Ax1. These reflections at the first face 13d change one of the light beams of the different direction and the direction of the first axis Ax1 to the other. The direction of the first axis Ax1 for the optical fibers in the holder is associated with the orientation of the installation face 21c (extending along the third reference plane R3EF) on a supporting base, such as the semiconductor device 15, supporting the stub device at the installation face 21c, which extends along the third reference plane R3EF. The stub device 13 (13a, 13b, and 13c) includes no part extending beyond the third reference plane R3EF (the level of the installation face 21c).

The optical fibers of the stub device 13 (13a, 13b, and 13c), specifically, the core ends 23c of the optical fibers 23 are optically coupled to optical coupling elements 15d disposed on the principal face 15a of the semiconductor device 15.

Specifically, light L1, which propagates in the core 23 of the optical fiber 23, is reflected so as to be emitted from the stub device 13 (13a, 13b, and 13c) through the second face 13e of the stub device 13 (13a, 13b, and 13c). Light L2, which is incident on the second face 13e of the stub device 13 (13a, 13b, and 13c), is reflected to the optical fiber 23, which can confine the incident light into the core 23a thereof, to propagate in the optical fiber 23.

The surface roughness of the stub device 13 (13a, 13b, and 13c) can be measured with an interferometer, such as a laser interferometer and a white light interferometer. The third surface roughness (S3RF) of the installation face 21c is larger than 0.05 micrometers in Ra. The area of the installation face 21c increases with the surface roughness Ra, and the enhanced area of the installation face 21c provides the fixation with a satisfactory adhesive strength. Desirably, the third surface roughness (S3RF) of the installation face 21c may be equal to or larger than 1.0 micrometer in Ra.

Desirably, the second end face 21e in the second face 13e of the stub device 13 (13a, 13b, and 13c) has a surface roughness of larger than zero micrometers and 0.05 micrometers or less in Ra. Optical scattering in input and output (e.g., a light coupling loss) decreases as the surface roughness in Ra is reduced. The first surface roughness (S1RF) of the first end face 21d in the first face 13d of the stub device 13 (13a, 13b, and 13c) is larger than zero micrometers and is equal to or smaller than 0.05 micrometers in Ra. Inventors' teachings reveal that polishing with a fine abrasive grain can provide the polished face with a surface roughness of 0.001 micrometers in Ra. The first and second end faces 21d and 21e each may have a surface roughness of 0.01 micrometers or less in Ra.

The holder 21 has an upper face 21f, which is opposite to the installation face 21c. A lower interval DL between the installation face 21f of the holder 21 and the center of the core 23a of the optical fiber 23 is smaller than an upper interval DU between the upper face 21f of the holder 21 and the center of the core 23a of the optical fiber 23. The lower interval DL can be equal to or smaller than 30 micrometers. The lower interval DL in this range can prevent light, which is emitted through the second face 13e after propagating in the optical fiber, from having a broadened spot size at the principal face 15a of the semiconductor device 15, allowing a highly efficient light couple therebetween. The lower interval DL may have a value of, for instance, 10 micrometers or more, and the lower interval DL in this range can prevent mechanical impact, exerted on the holder in the fabrication of the installation face 21c, from affecting the cores 23a of the optical fibers 23.

The stub device 13 (13a, 13b, and 13c) has exemplary sizes (length, width, and height) as follows.

Length (in the direction of the first axis Ax1): a range of 1 to 10 millimeters, for instance, 5 millimeters.
Width: a range of 2 to 10 millimeters, for instance, 6 millimeters.
Height: a range of 0.5 to 5 millimeters, for instance, 1.5 millimeters.
Optical fiber 23: a single-mode quartz optical fiber.
The holder 21: glass or ceramics, specifically, quartz, Tempax (trademark), Pyrex (trademark), alumina, or zirconia.
Refractive indices depend upon the kind of the material, optical wavelength, and ambient temperature. Optical glass for the holder 21 has a refractive index in a range of 1.4 to 1.6 in an optical communication wavelength range of 1.25 to 1.65 micrometers at room temperature. Desirably, the refractive index of the glass ranges from 1.44 to 1.46, and the refractive index of adhesive for the resin body 17 ranges from 1.4 to 1.6.

In the optical apparatus 11 (11a, 11b, and 11c), the semiconductor device 15 has a first region 15b and a second region 15c. The first and second regions 15b and 15c are arranged in the direction of the first axis Ax1. The first region 15b supports the installation face 21c of the stub device 13 (13a, 13b, and 13c). The second region 15c includes the optical coupling elements 15d, which are to be optically coupled to the stub device 13 (13a, 13b, and 13c). In order to position the installation face 21c to the second region 15c to install the stub device 13 (13a, 13b, and 13c) on the semiconductor device 15, the second region 15c has a substantially flat surface and does not include any electrode pad prepared to connect the semiconductor device 15 with an external device. The first region 15b of the semiconductor device 15 is located on one of the sides of the semiconductor device 15. The resin body 17 for adhesion is disposed on the first region 15b to fix the stub device 13 (13a, 13b, and 13c) to the first region 15b of the semiconductor device 15, and may cover the optical coupling elements 15d on the second region 15c to enhance optical coupling therebetween. An external optical connector is connected to the stub device 13 (13a, 13b, and 13c), which is positioned close to a side of the semiconductor device 15 in the first region 15b. Desirably, the rear portion of the stub device 13 (13a, 13b, 13c) slightly protrudes from the side of the semiconductor device 15.

In the optical apparatus 11 (11a, 11b, and 11c), the installation face 21c having a surface roughness larger than that of the second end face 21e allows the stub device to be firmly fixed to the first region 15b of the semiconductor device 15 with the resin body 17, such as adhesives. The first face 13d (extending along the first reference plane R1EF), which is inclined with the fourth reference plane R4EF at the first acute angle A1NG, has an inclination associated with the orientation of the installation face (extending along the third reference plane R3EF). The first face 13d enables optical reflection that can change light, which propagates in each of the optical fibers 23 in the direction of the first axis Ax1, into outgoing light propagating in a direction different from that of the first axis Ax1 through the second face 13e outward. The first face 13d also enables optical reflection that can change incident light, which comes through the second face at a desired angle in a direction different from that the first axis Ax1, into light propagating in the optical fiber in the direction of the first axis Ax1. These reflections at the first face 13d can change the direction of light from one of the direction of the first axis Ax1 and the different direction to the other. On the semiconductor device 15 supporting the stub device at the installation face 21c (extending along the third reference plane R3EF), the direction of the axis Ax1 for the optical fibers 23 is associated with the orientation of the installation face 21c (extending along the third reference plane R3EF) in the stub device 13 (13a, 13b, and 13c). The stub device 13 (13a, 13b, and 13c) does not include any part extending beyond the third reference plane R3EF (the level of the installation face 21c).

The stub device 13 (13a, 13b, and 13c) further includes a protecting member 25, which is disposed on the first end face 21d and the edge where the first and second end faces 21d and 21e meet, and the edge is on the line of intersection ITSCT where the first and second reference planes meet. The protecting member 25 extends on the first end face 21d to the line of the edge shared by the first and second end faces 21d and 21e, i.e., the line of intersection ITSCT, and can prevent the resin body, such as adhesives, from bonding on the first end face 21d. The protecting member 25 may include a reflecting face 25a oriented to the first end face 21d. In the stub device that includes no protecting member 25, the first face 13d can be mirror-polished to act as a reflector. The reflecting face 25a can include a refractive layer, such as gold, silver, aluminum, and a dielectric multilayer.

An exemplary reflection face 25a is listed below.
Material of the reflection face 25a: glass or ceramics, specifically, quartz, Tempax (trademark), Pyrex (trademark), alumina, or zirconia.

The stub device 13a (13) shown in FIGS. 1A and 1B will be described below. In the stub device 13a (13), the second end face 21e connects the installation face 21c to the first end face 21d (13d). The second reference plane R2EF is inclined with the fourth reference plane R4EF at an angle A5NG of larger than zero degrees, and this inclination allows the second end face 21e to connect the installation face 21c to the first end face 21d. Desirably, the angle A5NG is, for instance, larger than zero and equal to or smaller than 45 degrees. The cladding 23b of each of the optical fibers 23 appears on the second face 13e near the edge ITSCT, and has a cladding face 23e. The cores 23a of the optical fibers 23 are apart from the second face 13e. The cladding 23b on the second end face 21e (13e) has a shape with the part of an oval on the second face 13e. Light associated with the reflection at the first end face 21d (13d) passes through the cladding face 23e.

The stub device 13b (13) shown in FIGS. 2A and 2B will be described below. The holder 21 includes a connection face 21g, which connects the second end face 21e with the installation face 21c. The connection face 21g extends along a fifth reference plane R5EF, which intersects the first axis Ax1, to connect the second end face 21e to the installation face 21c. The connection face 21g does not reach the optical fibers 23, and is apart therefrom. The second reference plane R2EF inclined at a small acute angle or extending at zero degrees (i.e., in parallel) with respect to the fourth reference plane R4EF allows the connection face 21g to connect the second end face 21e to the installation face 21c. The second end face 21e is apart from the side faces 23f of the optical fibers 23. In the stub device 13b (13), light associated with the reflection at the first end face 21d propagates in the holder 21 and the cladding 23b of each of the optical fibers 23 from one of the first and second faces 13d and 13e of the stub device 13b (13) to the other in the direction of a second axis Ax2 intersecting the first axis Ax1. Desirably, the distance D2 between the installation face 21c and the second end face 21e is equal to or longer than 1 micrometer. The distance in this range allows the separation of the second end face 21e from the principal face 15a of the semiconductor device 15 in making optical coupling between the core ends 23c of the optical fibers 23 and the optical coupling elements 15d on the principal face 15a of the semiconductor device 15, and this separation can prevent the occurrence of scratching in the light propagating face. Desirably, the distance D2 is equal to or smaller than 1000 micrometers. A large distance D2 can make the distance between the cores 23c of the optical fibers 23 and the principal face 15a of the semiconductor device 15 large, and this large distance makes absorption and scattering of light propagating therebetween increased, so that the distance D2 in the above range can make the optical loss reduced. Desirably, the distance D3 between the installation face 21c and the side faces 23f of the optical fibers 23 is equal to or larger than 1 micrometer because of the distance D2 of 1 micrometer or longer as described above. Desirably, the distance D3 is equal to or smaller than 1000 micrometers. A large distance D3 makes a distance between the cores 23c of the optical fibers 23 and the principal face 15a of the semiconductor device 15 large, and this large distance between the cores and the principal face makes absorption and scattering of light propagating therebetween increased, so that the distance D3 in the above range can make the optical loss reduced. The distance D3 is larger than the distance D2. Desirably, the distance D4 between the second end face 21c and the side faces 23f is equal to or smaller than 1000 micrometers. A large distance D4 makes a distance between the cores 23c of the optical fibers 23 and the principal face 15a of the semiconductor device 15 large, and this large distance between the cores and the principal face makes absorption and scattering of light propagating therebetween increased, so that the distance D4 in the above range can make the optical loss reduced.

The stub device 13c (13) shown in FIGS. 3A and 3B will be described below. The holder 21 includes a connection face 21g, which connects the second end face 21e with the installation face 21c. The connection face 21g extends along the fifth reference plane R5EF intersecting the first axis Ax1, so that the connection face 21g connects the second end face 21e with the installation face 21c. The connection face 21g reaches the optical fibers 23. The optical fibers 23 each have a cladding face 23e, and the cladding face 23e extends in the direction of the first axis Ax1 to reach the connection face 21g. The connection face 21g, which connects the second end face 21e to the installation face 21c, allows the second reference plane R2EF to extend, for instance, at a small acute angle or zero degrees with respect to the fourth reference plane R4EF. Desirably, the distance D2 (difference in level) between the installation face 21c and the second end face 21e is equal to or longer than 1 micrometer. The distance D2 in this range allows the separation of the second end face 21e from the principal face 15a of the semiconductor device 15 in making optical coupling between the core ends 23c of the optical fibers 23 and the optical coupling elements 15d on the principal face 15a of the semiconductor device 15. This separation can prevent the occurrence of scratching in the light propagating face. Desirably, the distance D2 is equal to or smaller than 30 micrometers. A small distance D2 makes a distance between the cores 23c of the optical fibers 23 and the principal face 15a of the semiconductor device 15 small. This small distance prevents the spot size of light propagating between the core 23c of the optical fiber 23 and the principal face 15a of the semiconductor device 15 from becoming too large, and allows a highly efficient optical connection therebetween with no additional optical device interposed, such as a focusing lens. Desirably, the distance D5 between the installation face 21c and the cores 23a of the optical fibers 23 is made equal to or larger than 1 micrometer because of the distance D2 of 1 micrometer or more as described above. Desirably, the distance D5 is equal to or smaller than 30 micrometers. A small distance D5 can make a distance between the core 23c of the optical fiber 23 and the principal face 15a of the semiconductor device 15 small. This small distance prevents the spot size of light propagating between the core 23c and the principal face 15a from becoming too large, and allows a highly efficient optical connection between the cores 23c of the optical fibers 23 and the principal face 15a of the semiconductor device 15 with no additional optical device interposed, such as a focusing lens. The distance D5 of 30 micrometers or less causes the claddings 23b of the optical fibers 23 to appear on the installation face 21c. The distance D5 is larger than the distance D2. Desirably, the distance D4 is equal to or smaller than 30 micrometers. A small distance D4 makes a distance between the cores 23c and the cladding faces 23e (the second end face 21e) of the optical fibers 23 reduced. This reduced distance can prevent the spot size of light propagating between the cores 23c of the optical fibers 23 and the principal face 15a of the semiconductor device 15 from becoming too large, and allows a highly efficient optical connection therebetween with no additional optical device interposed, such as a focusing lens.

The optical fibers 23 each include the cladding face 23e extending along the second reference plane R2EF. The cladding face 23e is strip-shaped to extend in the direction of the first axis Ax1. The second end face 21e and the cladding faces 23e of the optical fibers 23 are arranged along the second reference plane R2EF to build the second face 13e. The claddings 23b of the optical fibers 23 form a part of the outside appearance of the stub device 13c (13).

The first end face 21d and the end faces of the optical fibers 23 are arranged along the first reference plane R1EF. Light reflected at the end face of the optical fiber 23 propagates in the cladding 23b thereof from one of the first and second faces 13d and 13e of the stub device 13c (13) to the other in the direction of the second axis Ax2 intersecting the first axis Ax1.

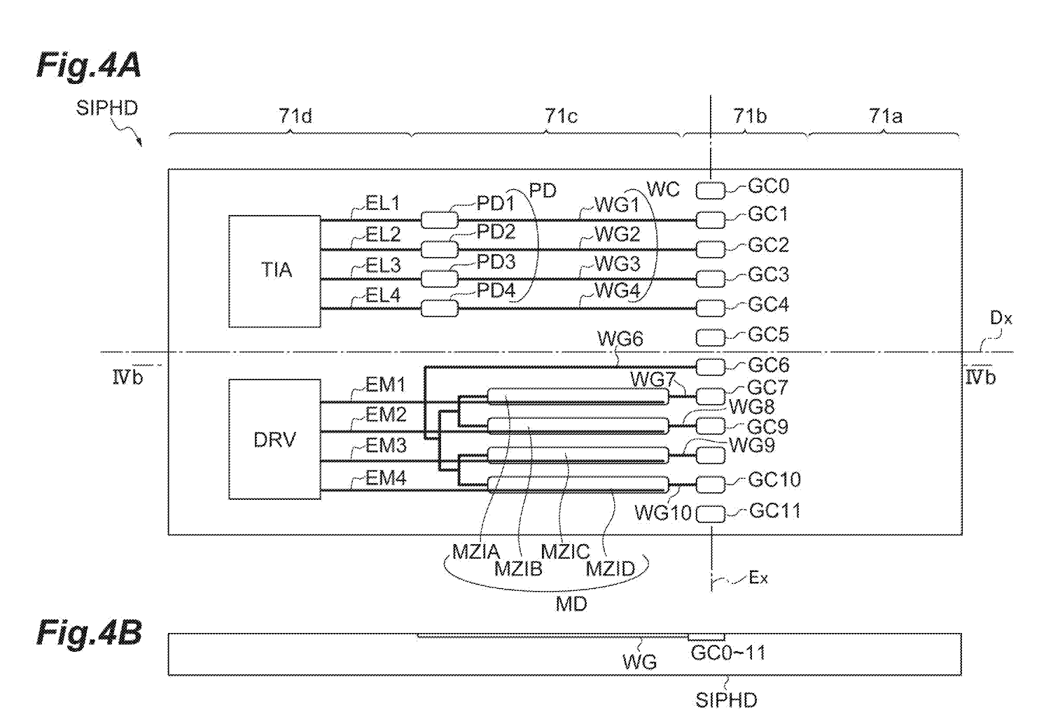

FIGS. 4A and 4B schematically show a silicon photonics semiconductor device, which is prepared for the optical apparatus according to the present embodiment. FIG. 4A is a plan view showing the silicon photonics semiconductor device according to the present embodiment, and FIG. 4B is a cross-sectional view, taken along line IVb-IVb shown in FIG. 4A, showing the silicon photonics semiconductor device according to the present embodiment. Referring to FIG. 4A, the silicon photonics semiconductor device SIPHD has optical coupling elements, such as grating couplers GC0, GC1, GC2, GC3, GC4, GC5, GC6, GC7, GC8, GC9, GC10, or GC11. In the present embodiment, the grating couplers GC1 to GC4 are prepared for an optical receiver.

Optical signals from the grating couplers GC1 to GC4 are supplied to a photodetector PD through an optical circuit WC. In the present embodiment, the optical circuit WC includes optical waveguides WG1 to WG4. The grating couplers GC1 to GC4 are optically coupled to the photodiodes PD1 to PD4 through the optical waveguides WG1 to WG4, respectively. The photodiodes PD1 to PD4 are connected to an electrical circuit TIA (for instance, transimpedance amplifier) through interconnects EL1 to EL4, respectively. The electrical circuit TIA conducts the processing (for instance, current-voltage conversion or amplifier) of electrical signals (for instance, optical current) from the photodiodes PD1 to PD4 to produce electrical signals in response to the received optical signals.

The grating couplers GC6 to GC10 are prepared for an optical transmitter. In the present embodiment, a laser beam from the grating coupler GC6 is supplied to an optical modulator. The optical modulator includes, for instance, Mach-Zehnder modulators MZIA, MZIB, MZIC, and MZID. The Mach-Zehnder modulators MZIA, MZIB, MZIC, and MZID receive electrical signals EM1 to EM4 from the driving circuit DRV, and produce modulated optical signals in response to the electrical signals EM1 to EM4, respectively. These modulated optical signals propagate through optical waveguides WG7 to WG10 to the grating couplers GC7 to GC10, respectively.

The silicon photonics semiconductor device SIPHD includes a first portion 71a, a second portion 71b, a third portion 71c, and a fourth portion 71d, which are arranged in the direction of a first device axis Dx. The first portion 71a is prepared for installing the stub device 13 (13a, 13b, and 13c). The second portion 71a includes the arrangement of the grating couplers GC0 to GC11. The grating couplers GC0 to GC11 are arranged along a second device axis Ex on the second portion 71b adjoining the first portion 71a. The second device axis Ex intersects the first device axis Dx. The third portion 71c includes an optical device, such as a semiconductor optical device or an optical modulator. The fourth portion 71d includes electrical circuits, such as the electrical circuit TIA or the driving circuit DRV.

Referring to FIG. 4B, in the silicon photonics semiconductor device SIPHD, the grating couplers GC0 to GC11 are connected to the waveguides WG.

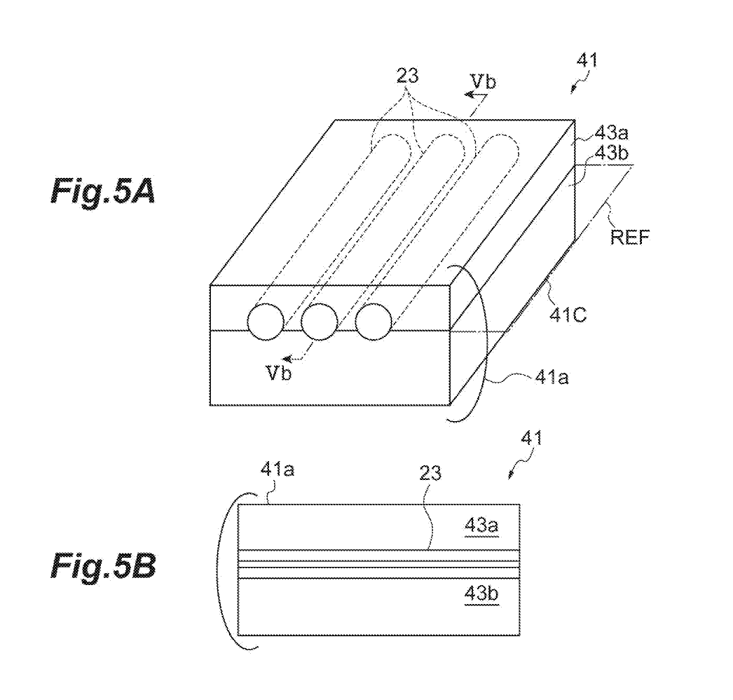

Referring to FIGS. 5A, 5B, 6A, 6B, 6C, 7A, 7B, 7C, 7D, 7E and 7F, a method for fabricating the stub device 13 (13a, 13b, and 13c) will be described below. In the following description, in order to facilitate understanding, the same portions will be denoted by the same reference numerals for the stub device 13 (13a, 13b, and 13c), where possible. FIG. 5B is a cross-sectional view, taken along line Vb-Vb shown in FIG. 5A. As shown in FIG. 5A, an optical fiber array 41 is prepared. Preparing the optical fiber array 41 is conducted by, for instance, fabricating the optical fiber array 41. The optical fiber array 41 is fabricated as follows. The optical fibers 23 are disposed between two glasses 43a and 43b, and the optical fibers 23 thus disposed are fixed to the glasses 43a and 43b with adhesives. The optical fibers 23 are arranged along a reference plane REF thereon. The optical fiber array 41 has an upper face 41b and a lower face 41c, which are substantially parallel to the reference plane REF.

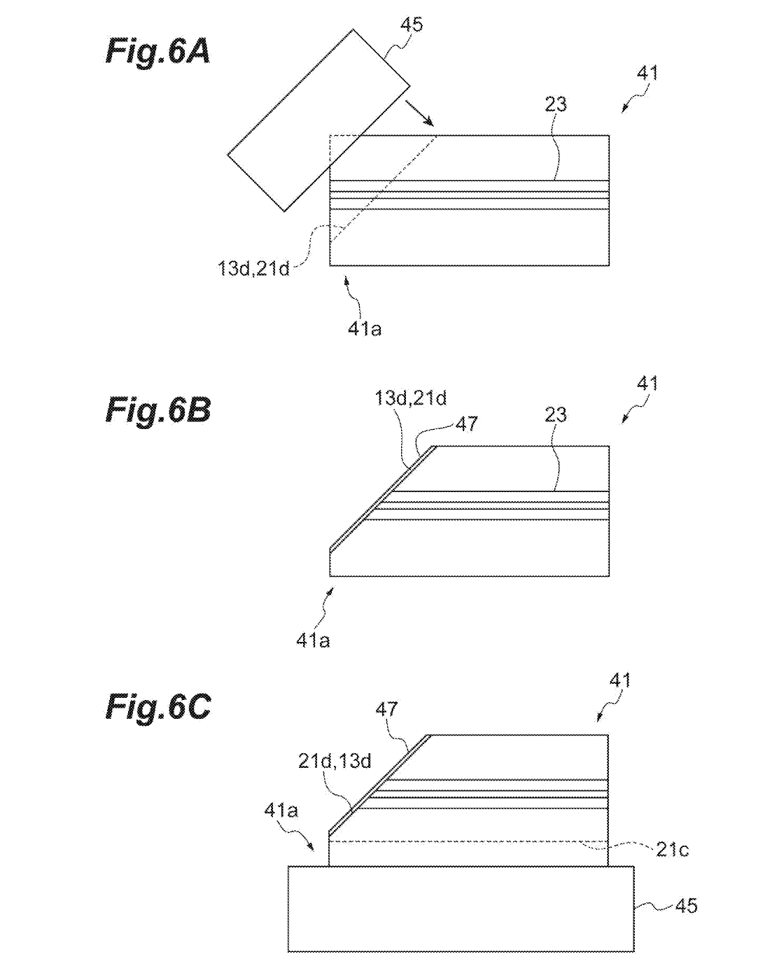

As shown in FIG. 6A, the optical fiber array 41 is set in a polishing machine 45. The optical fiber array 41 is polished with the polishing machine 45 to remove a part of an end portion 41a thereof, thereby forming the first face 13d (the first end face 21d). Specifically, the end portion 41a of the optical fiber array 41 is polished so as to reach the ends of the optical fibers 23, thereby removing the upper edge of the end portion 41a. This polishing process fabricates the first end face 21d and first face 13d. The first face 13d has a surface roughness, Ra, of, for instance, 0.001 micrometers.

As shown in FIG. 6B, a reflection film 47 is fabricated on the first end face 21d of the optical fiber array 41 and the first face 13d, which have already been formed by polishing. The reflection film 47 is fabricated, for instance, by vapor deposition. The reflection film 47 may include a reflection layer, such as gold, silver, aluminum, and a dielectric multilayer.

As shown in FIG. 6C, the optical fiber array 41 is set in the polishing machine 45. A part of the lower face 41c of the optical fiber array 41 is polished with the polishing machine 45 to form the installation face 21c. The optical fiber array 41 is thinned by polishing the lower face 41c of the optical fiber array 41, and this polishing allows the distance between the polished face and side faces of the optical fibers 23 to gradually decrease. This polishing process fabricates the installation face 21c. The installation face 21c has a surface roughness Ra of, for instance, 1 micrometer.

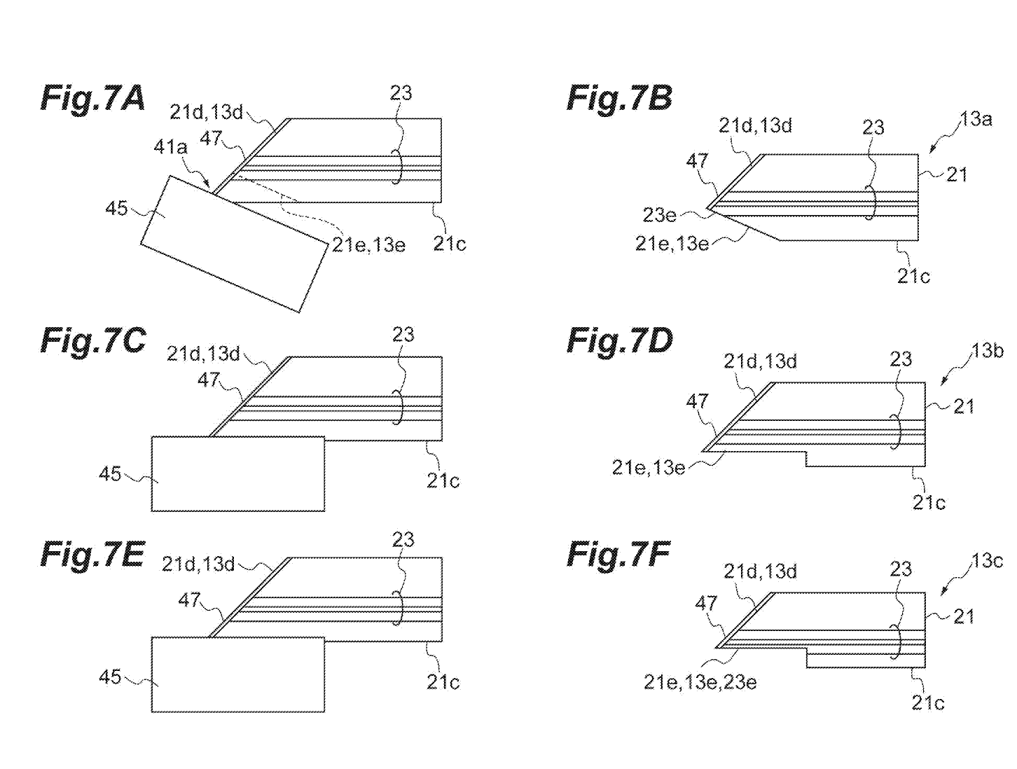

A method for fabricating the stub device 13a (13) as shown in FIGS. 1A and 1B will be described below. In fabricating the stub device 13a (13), after making the installation face 21c, as shown in FIG. 7A, the optical fiber array 41 is set in the polishing machine 45. The lower face 41c of the optical fiber array 41 is polished with the polishing machine 45 to form the second face 13e (the second end face 21e), and specifically, the polishing process removes the lower edge of the end portion 41a of the optical fiber array 41 so as to reach the claddings of the optical fibers 23, thereby forming a polished face which is inclined to the reference plane along which the optical fibers 23 are arranged. The polishing process fabricates the second end face 21e and second face 13e as shown in FIG. 7B. The second face 13e has a surface roughness Ra of, for instance, 0.001 micrometers. The polishing process brings the stub device 13a (13) to completion.

A method for fabricating the stub device 13b (13) as shown in FIGS. 2A and 2B will be described below. In fabricating the stub device 13b (13), after making the installation face 21c, as shown in FIG. 7C, the optical fiber array 41 is installed in the polishing machine 45. A part of the end portion 41a of the optical fiber array 41 is polished to form the second face 13e (the second end face 21e), and specifically, the polishing process removes the lower edge of the end portion 41a of the optical fiber array 41 and is stopped prior to reaching the claddings of the optical fibers 23, thereby forming a polished face, which is substantially parallel to reference face on which the optical fibers 23 are arranged. This polishing process fabricates the second end face 21e and the second face 13e as shown in FIG. 7D. In the second face 13e, the surface of the holder 21 appears. The second face 13e has a surface roughness Ra of, for instance, 0.001 micrometers. The polishing process brings the stub device 13b (13) to completion.

A method for fabricating the stub device 13c (13) as shown in FIGS. 3A and 3B will be described below. In fabricating the stub device 13c (13), after making the installation face 21c, as shown in FIG. 7E, the optical fiber array 41 is set in the polishing machine 45. A part of the end portion 41a of the optical fiber array 41 is polished to form the second face 13e (the second end face 21e), and specifically, the polishing process removes the lower edge of the end portion 41a of the optical fiber array 41 so as to reach the claddings of the optical fibers 23, thereby forming a polished face, which is substantially parallel to reference face on which the optical fibers 23 are arranged. This polishing process fabricates the second end face 21e and second face 13e as shown in FIG. 7F. In the second face 13e, the strip-shaped cladding of the optical fiber 23 appears. The second face 13e has a surface roughness Ra of, for instance, 0.001 micrometers. The polishing process brings the stub device 13c (13) to completion.

The present embodiments can provide a stub device which can reduce optical scattering in input and output of light propagating in an optical fiber having an oblique face and provide fixation of the optical fiber with a satisfactory adhesive strength, and also provide an optical apparatus including the stub device.

Having described and illustrated the principle of the invention in a preferred embodiment thereof, it is appreciated by those having skill in the art that the invention can be modified in arrangement and detail without departing from such principles. We therefore claim all modifications and variations coining within the spirit and scope of the following claims.

What is claimed is:

1. A stub device comprising:
a holder including a first portion and a second portion, the first portion and the second portion being arranged in a direction of a first axis, the first portion having a first end face and a second end face, and the second portion having an installation face; and
optical fibers held by the holder so as to extend in the direction of the first axis, the optical fibers having core ends, and the core ends and the first end face of the holder being arranged along a first reference plane,
the second end face of the holder extending along a second reference plane, the second reference plane being inclined with the first reference plane at an acute angle, and the second end face of the holder being apart from cores of the optical fibers in the first portion,
the installation face being apart from cores of the optical fibers in the second portion and extending along a third reference plane, and the third reference plane being inclined with the first reference plane at an acute angle,
the optical fibers being arranged along a fourth reference plane, the fourth reference plane being inclined with the first reference plane at an acute angle, and
the installation face having a surface roughness larger than that of the second end face.

2. The stub device according to claim 1, wherein the installation face has a surface roughness Ra of larger than 0.05 micrometers.

3. The stub device according to claim 1, further comprising a protecting member, the protecting member being disposed on the first end face and reaching an edge at which the first end face and the second end face meet.

4. The stub device according to claim 1, wherein the second end face extends to connect the installation face with the first end face.

5. The stub device according to claim 1,
wherein the holder includes a connection face extending along a fifth reference plane to connect the second end face with the installation face, and the fifth reference plane intersects the first axis,
the first end face and the installation face extend in the direction of the first axis.

6. The stub device according to claim 5,
wherein the optical fibers each include a cladding face extending along the second reference plane in the direction of the first axis to the connection face.

7. The stub device according to claim 5,
wherein the second end face is apart from side faces of the optical fibers.

8. An optical apparatus comprising:
a stub device;
a semiconductor device having a first region and a second region, the second region including an optical coupling element optically coupled to the stub device; and
a resin body disposed between the semiconductor device and the stub device,
the stub device including:
a holder having a first portion and a second portion, the first portion and the second portion being arranged in a direction of a first axis, the first portion having a first end face and a second end face, and the second portion having an installation face; and
optical fibers held by the holder so as to extend in the direction of the first axis, the optical fibers having core ends, and the core ends and the first end face of the holder being arranged along a first reference plane,
the second end face of the holder extending along a second reference plane, the second reference plane being inclined with the first reference plane at an acute angle, and the second end face of the holder being apart from cores of the optical fibers in the first portion,
the installation face being apart from cores of the optical fibers in the second portion and extending along a third reference plane, the third reference plane being inclined with the first reference plane at an acute angle, and the installation face being supported by the first region,
the optical fibers being arranged along a fourth reference plane, the fourth reference plane being inclined with the first reference plane at an acute angle, and
the installation face having a surface roughness larger than that of the second end face.
